(19) United States
(12) Patent Application Publication
(10) Pub. No.: US 2015/0070911 A1
(43) Pub. Date: Mar. 12, 2015

(54) OPTICAL SEMICONDUCTOR LIGHTING APPARATUS

(71) Applicant: Posco LED Company Ltd., Seongnam-si (KR)

(72) Inventors: Dong Soo Kim, Seongnam-si (KR); Seok Jin Kang, Seongnam-si (KR); Kyoo Seok Kim, Seongnam-si (KR); Yoon Gil Jang, Seongnam-si (KR); Dong Hee Kim, Seongnam-si (KR); Seong Bok Yoon, Seongnam-si (KR); Jung Hwa Kim, Seongnam-si (KR)

(21) Appl. No.: 14/542,143

(22) Filed: Nov. 14, 2014

Related U.S. Application Data
(63) Continuation-in-part of application No. 14/056,663, filed on Oct. 17, 2013, now Pat. No. 8,915,618.
Application No. 14/056,663 is a continuation of application No. 13/596,582, filed on Aug. 28, 2012, now Pat. No. 8,585,250.

(30) Foreign Application Priority Data
Jul. 10, 2012 (KR) 10-2012-0075103
Jul. 13, 2012 (KR) 10-2012-0076852

(51) Int. Cl. F21V 29/00

(52) U.S. Cl. CPC F21V 29/2268; F21Y 2101/02
USPC 362/373

(57) ABSTRACT

A first heat sinking path formed in a forming direction of a heat sink unit disposed radially in a housing where a light emitting module is mounted. A second heat sinking path is formed along an edge of the light emitting module. By providing a light engine concept in which a light emitting module, an optical member, and a heat sink unit are included and a bottom surface is gradually widened from one side to the other side, an optical semiconductor lighting apparatus can reduce a total weight of a product, can further improve heat dissipation efficiency by inducing natural convection, is simple in the product assembly and installation, and is easy in maintenance, and can provide products with high reliability by increasing the arrangement efficiency of semiconductor optical devices per unit area.

### CROSS-REFERENCES TO RELATED APPLICATIONS

This application is a continuation-in-part of U.S. patent application Ser. No. 14/056,663, filed on Oct. 17, 2013, which is a continuation of U.S. patent application Ser. No. 13/596,582, filed on Aug. 28, 2012, and now issued as U.S. Pat. No. 8,585,250, and claims priority from and the benefit of Korean Patent Application No. 10-2012-0075103, filed on Jul. 10, 2012, and Korean Patent Application No. 10-2012-0076852, filed on Jul. 13, 2012, each of which is hereby incorporated by reference for all purpose as if fully set forth herein.

### BACKGROUND OF THE INVENTION

1. Field of the Invention

The present invention relates to an optical semiconductor lighting apparatus.

2. Description of the Related Art

Compared with incandescent light and fluorescent light, optical semiconductors, such as LEDs or LDs, consume low power, have a long lifespan, and have high durability and high brightness. Due to these advantages, optical semiconductors have recently attracted much attention as one of components for lighting.

Typically, in the lighting apparatuses using such optical semiconductors, heat is inevitably generated from the optical semiconductors. Therefore, it is necessary to install heat sinks at heat generation sites so as to discharge the generated heat to the outside.

As the optical semiconductors have recently become popular and have been mass-produced, unit costs of the optical semiconductors have also been lowered. Therefore, the lighting apparatuses using the optical semiconductors have tended to be used for high power industrial lighting, such as factory lighting, streetlight, or security light.

In the lighting apparatuses using the optical semiconductors, which are used for the high power industrial lighting, generation of heat increases in proportion to the size and power of the lighting apparatuses. As a result, it is necessary to increase the capacity and volume of the heat sink so as to demonstrate excellent heat dissipation performance.

Generally, heat sinks mounted on the lighting apparatuses using the optical semiconductors are manufactured by die casting or the like, such that the heat sinks are integrally or detachably connected to a housing. However, the heat sinks manufactured in such a manner increase the total weight of the product and increase the manufacturing costs and the amount of raw materials used.

In particular, in the case of the conventional heat sinks manufactured by die casting, heat sink fins cannot be formed to have a thickness below a predetermined reference value due to characteristics of the manufacturing method thereof. Hence, a heat dissipation area intended at a limited site is narrow, and the volume and size of the heat sink is increased if a plurality of heat sink fins are formed for securing a sufficient heat dissipation area.

Meanwhile, in this regard, if a heat sink is manufactured in a shape of a heat sink plate by using a sheet (thin plate), a sufficient heat dissipation area may be secured. However, due to the structural limitation that the heat sink should be arranged in a line contact manner, heat generated from optical semiconductors may not be effectively transferred and discharged to the outside.

Furthermore, in the lighting apparatus using the optical semiconductor, a circuit board, on which the optical semiconductors are disposed, is connected to a heat sink, and the circuit board is embedded in a housing. An optical member, such as a lens, which is installed in the housing, allows light from the optical semiconductors to be irradiated more widely or narrowly.

In most cases, the lighting apparatus using the optical semiconductor is disposed on a rectangular or circular circuit board for convenience of manufacturing, and a housing is also rectangular or circular.

However, in view of the number of the lighting apparatuses arranged per unit area in order for high power, if a large number of lighting apparatuses are arranged, the total weight and volume thereof are increased due to the limitation of the structural shape.

### SUMMARY OF THE INVENTION

An aspect of the present invention is directed to provide an optical semiconductor lighting apparatus that can reduce a total weight of a product.

Another aspect of the present invention is directed to provide an optical semiconductor lighting apparatus that can further improve the heat dissipation efficiency by inducing natural convection.

Another aspect of the present invention is directed to provide an optical semiconductor lighting apparatus that is simple in the product assembly and installation and is easy in maintenance.

Another aspect of the present invention is directed to provide an optical semiconductor lighting apparatus that can provide products with high reliability by increasing the arrangement efficiency of semiconductor optical devices per unit area.

According to an embodiment of the present invention, an optical semiconductor lighting apparatus includes: a housing; a light emitting module including at least one or more semiconductor optical devices and disposed at an outer side of a bottom surface of the housing; a heat sink unit disposed radially at an inner side of the bottom surface of the housing and forming a communication space at a central portion of the inner side of the bottom surface of the housing; a first heat sinking path formed radially from the central portion of the inner side of the bottom surface of the housing; and a second heat sinking path formed along an edge of the bottom surface of the housing in a vertical direction.

The heat sink unit may include a plurality of heat sink elements each including a pair of heat sink elements that are perpendicular to the bottom surface of the housing and face each other.

The optical semiconductor lighting apparatus may further include a core fixing portion that is disposed at the central portion of the inner side of the bottom surface of the housing and fixes an inner end portion of the heat sink unit.

An outer end portion of the heat sink unit may communicate with the second heat sinking path formed from the outer side of the bottom surface of the housing.

The housing further may include a side wall extending along the edge of the bottom surface of the housing. The heat sink unit may be accommodated inside the side wall. The second heat sinking path may be formed in parallel to the side wall.

The housing may further include a cover that is connected to an upper edge of the side wall and has a communication hole at a central portion thereof.

The housing may further include: a cover mutually communicating with the first and second heat sinking paths and having a communication hole at a central portion thereof; and a plurality of upper vent slot penetrating on circumferences of a plurality of virtual concentric circles formed along a direction in which the cover is formed.

The housing may further include a cover that is disposed at an upper side of the heat sink unit, is connected to the housing, and has a communication hole connected to the communication space.

The cover may further include a plurality of upper vent slots penetrating circumferences of a plurality of virtual concentric circles formed along a direction in which the cover is formed.

The housing may further include a ventilation fan disposed in the communication space.

The housing may further include a plurality of lower vent slots penetrating the bottom surface of the housing along an edge of the light emitting module, and the lower vent slots may mutually communicate with the second heat sinking path.

According to another embodiment of the present invention, an optical semiconductor lighting apparatus includes: a housing in which at least one or more semiconductor optical devices are disposed at an outer side of a bottom surface thereof; a plurality of bottom sheets disposed radially at an inner side of the bottom surface of the housing; and a heat sink sheet extending along both edges of the bottom sheet and facing each other.

The optical semiconductor lighting apparatus may further include: an extension sheet extending from an inner end portion of the bottom sheet toward a central portion of the inner side of the bottom surface of the housing; and a fixing sheet extending along both edges of the extension sheet and facing each other, wherein the fixing sheet is connected to the heat sink sheet.

The optical semiconductor lighting apparatus may further include a core fixing portion that is disposed at the central portion of the inner side of the bottom surface of the housing and fixes an upper edge of the fixing sheet.

The bottom sheet may be formed in a tapered shape, such that the bottom sheet is gradually widened toward the edge of the inner side of the bottom surface of the housing.

The housing may further include a plurality of fixing protrusions that protrude from the inner side of the bottom surface of the housing and are disposed along both edges of the bottom sheet.

The housing may further include a communication space formed between the plurality of bottom sheets and the inner end portion of the heat sink sheet from the central portion of the bottom surface of the housing, and the communication space may communicate with the first heat sinking path.

The housing may further include a ventilation fan disposed in the communication space.

The term “semiconductor optical device” used in claims and the detailed description refers to a light emitting diode (LED) chip or the like that includes or uses an optical semiconductor.

The semiconductor optical devices may include package level devices with various types of optical semiconductors, including the LED chip.

### BRIEF DESCRIPTION OF THE DRAWINGS

FIG. 1 is a perspective view illustrating an overall configuration of an optical semiconductor lighting apparatus according to an embodiment of the present invention.

FIG. 2 is a cross-sectional view taken along line A-A′ of FIG. 1.

FIG. 3 is a partial conceptual diagram viewed from a viewpoint B of FIG. 1.

FIG. 4 is a partial conceptual diagram viewed from a viewpoint C of FIG. 1.

FIGS. 5 to 6 are diagrams illustrating an overall configuration of a unit heat sink element constituting a heat sink unit that is an essential part of the optical semiconductor lighting apparatus according to the embodiment of the present invention.

FIG. 7 is a perspective view illustrating an overall configuration of an optical semiconductor lighting apparatus according to an embodiment of the present invention.

FIG. 8 is a cross-sectional view taken along line E-E′ of FIG. 7.

FIG. 9 is a perspective view illustrating an overall configuration of an optical semiconductor lighting apparatus according to another embodiment of the present invention.

FIG. 10 is a cross-sectional view taken along line F-F′ of FIG. 9.

FIG. 11 is a partial conceptual diagram viewed from a viewpoint G of FIG. 9.

FIG. 12 is a partial conceptual diagram viewed from a viewpoint I of FIG. 9.

FIG. 13 and FIG. 14 are diagrams illustrating an overall configuration of a unit heat sink element constituting a heat sink unit that is an essential part of the optical semiconductor lighting apparatus according to another embodiment of the present invention.

FIG. 15, FIG. 16, FIG. 17, and FIG. 18 are conceptual diagrams illustrating actual application examples of optical semiconductor lighting apparatuses according to various embodiments of the present invention.

FIG. 19 is a cross-sectional view taken along line K-K′ of FIG. 17.

FIG. 20 is a perspective view illustrating an overall configuration of an optical semiconductor lighting apparatus according to another exemplary embodiment of the present invention.

FIG. 21 is a cross-sectional view taken along line L-L′ of FIG. 20.

FIG. 22 is a conceptual diagram viewed from a viewpoint M of FIG. 20.

FIG. 23 is a perspective view illustrating an overall configuration of a first heat sink module that can be mounted on the apparatus disclosed in FIG. 20.

FIG. 24, FIG. 25, FIG. 26, and FIG. 27 are conceptual diagrams illustrating actual application examples of the first heat sink module mounted on the apparatus shown in FIG. 20.

FIG. 28 is a conceptual diagram of the apparatus disclosed in FIG. 27 viewed from a viewpoint of N of FIG. 20.

FIG. 29 is a perspective view illustrating an overall configuration of a second heat sink module can be mounted on the apparatus disclosed in FIG. 20.

### DETAILED DESCRIPTION OF EXEMPLARY EMBODIMENTS

Exemplary embodiments of the present invention will be described below in detail with reference to the accompanying drawings.

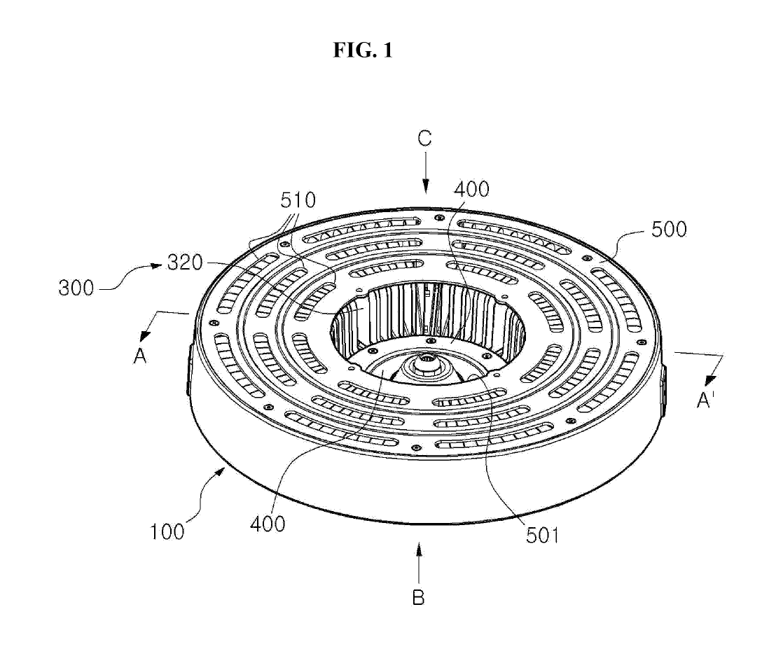

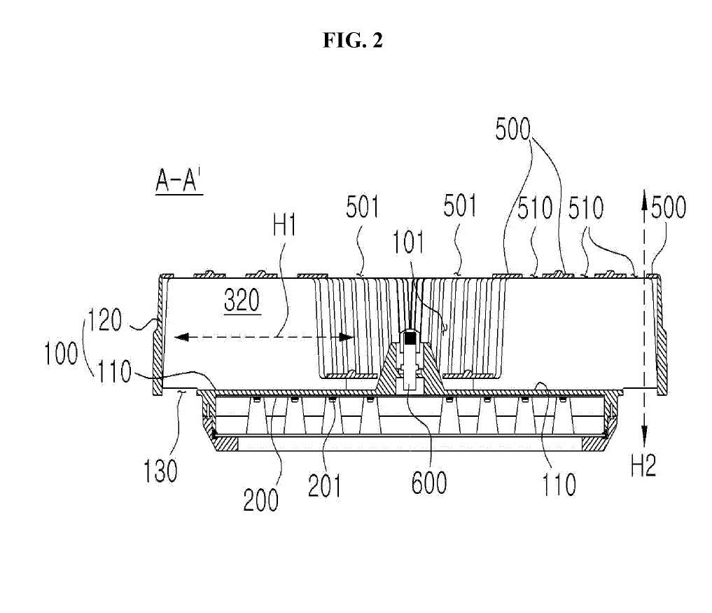

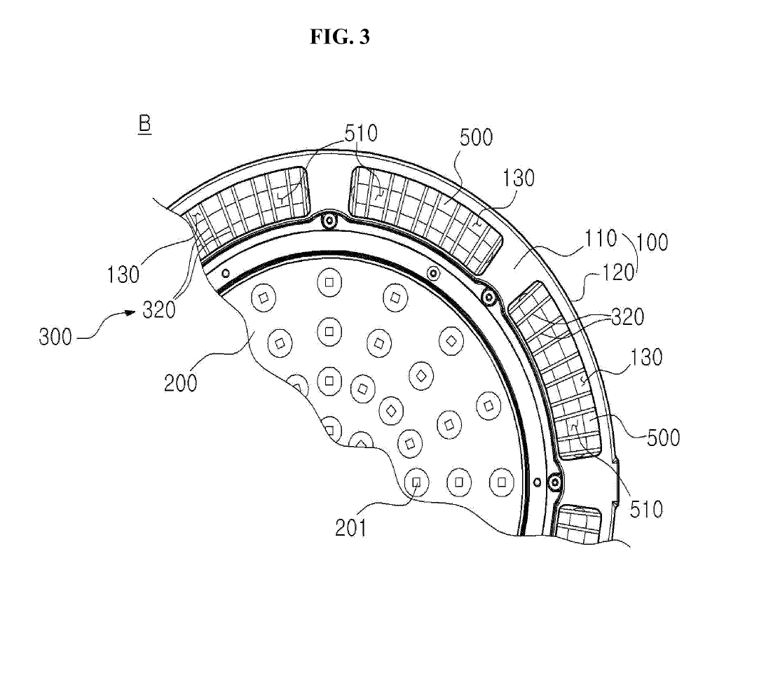

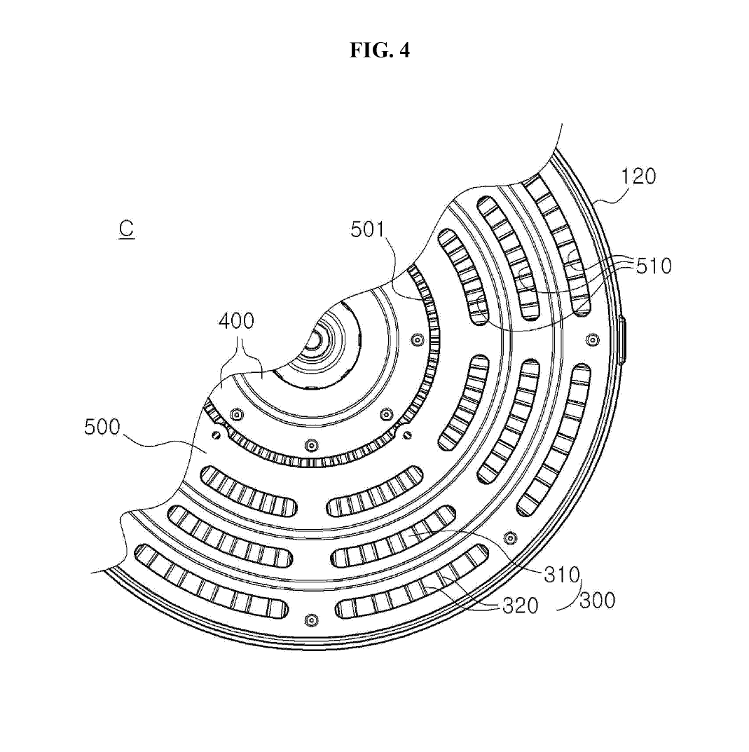

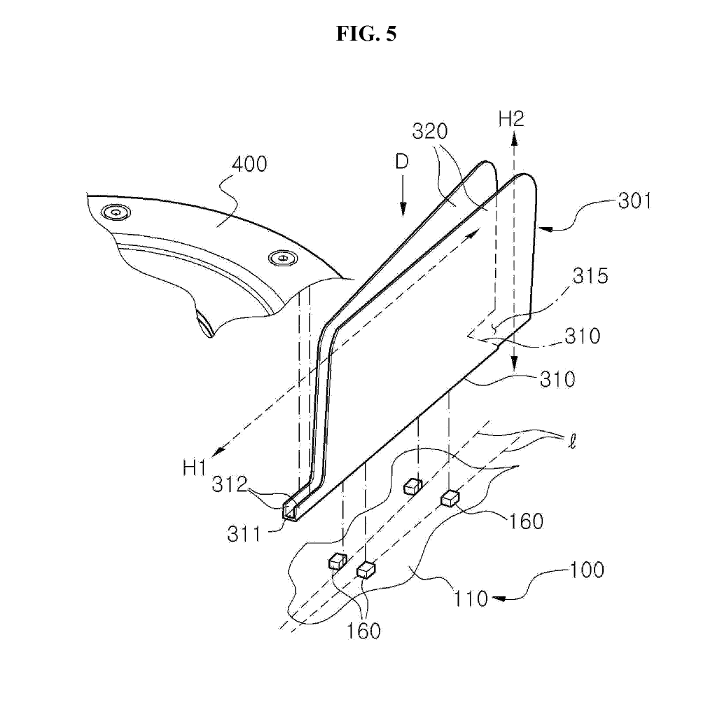

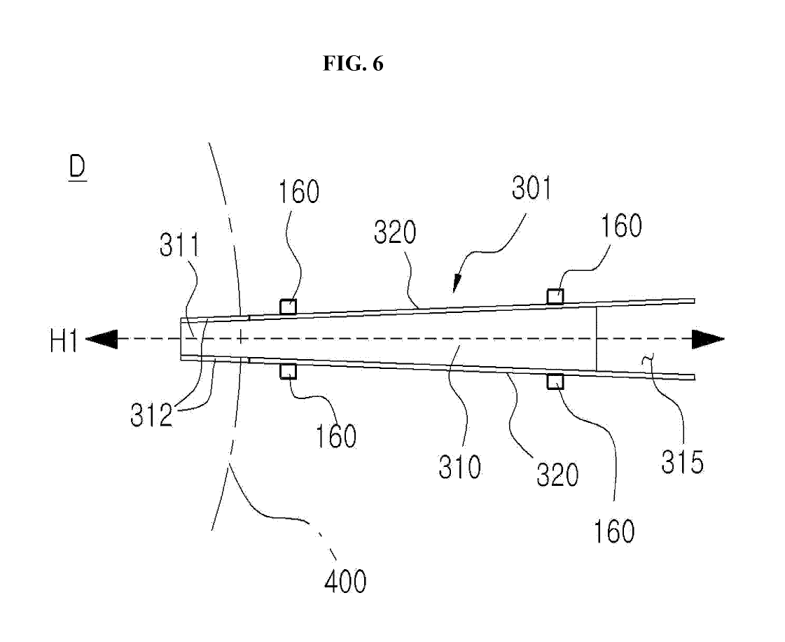

FIG. 1 is a perspective view illustrating an overall configuration of an optical semiconductor lighting apparatus according to an embodiment of the present invention. FIG. 2 is a cross-sectional view taken along line A-A′ of FIG. 1. FIG. 3 is a partial conceptual diagram viewed from a viewpoint B of FIG. 1. FIG. 4 is a partial conceptual diagram viewed from a viewpoint C of FIG. 1. FIGS. 5 to 6 are diagrams illustrating an overall configuration of a unit heat sink element constituting a heat sink unit that is an essential part of an optical semiconductor lighting apparatus according to an embodiment of the present invention.

As illustrated, the optical semiconductor lighting apparatus according to the embodiment of the present invention is configured such that a heat sink unit 300 is mounted on a housing 100 where a light emitting module 200 is disposed, and first and second heat sinking paths H1 and H2 are formed inside the housing 100.

For reference, reference numeral 600 in FIG. 2 denotes a waterproof connector. In FIG. 2, an outer side of a bottom surface 110 refers to a side facing a lower side of the drawing from the bottom surface 110, and an inner side of the bottom surface 110 refers to a side facing an upper side of the drawing from the bottom surface 110. The outer side and the inner side of the bottom surface 110 are equally applied throughout the drawings.

The housing 100 provides a space for mounting the light emitting module 200 and the heat sink unit 300, and the light emitting module 200 includes at least one or more semiconductor optical devices 201 and is disposed at the outer side of the bottom surface 110 of the housing 100. The light emitting module 200 serves as a light source.

The heat sink unit 300 is disposed radially at the inner side of the bottom surface 110 of the housing 100, and forms a communication space 101 at an inner central portion of the bottom surface 110 of the housing 100. The heat sink unit 300 discharges heat generated from the light emitting module 200 to the outside of the housing 100.

The first heat sinking path H1 is formed radially from the inner central portion of the bottom surface 110 of the housing 100. To be specific, the first heat sinking path H1 may be formed radially along the direction in which the respective heat sink units 300 are formed.

The second heat sinking path H2 is formed along the edge of the bottom surface 110 of the housing 100 in a vertical direction. To be specific, the second heat sinking path H2 may be formed to communicate in the vertical direction of the housing 100 along the edge of the light emitting module 200.

Therefore, as illustrated, natural convection is actively induced by forming a plurality of paths through which heat generated from the light emitting module 200 is discharged by the first and second heat sinking paths H1 and H2, thereby further increasing the heat dissipation efficiency.

It is apparent that the following various embodiments as well as the above-described embodiment can also be applied to the present invention.

As described above, the housing 100 provides the space for mounting the light emitting module 200 and the heat sink unit 300, and further includes a side wall 120 (see FIG. 2) extending along the edge of the bottom surface 110 of the housing 100. The side wall 120 surrounds the outside of the heat sink unit 300, and the second heat sinking path H2 is formed in parallel to the side wall 120.

The housing 100 further includes a plurality of lower vent slots 130 penetrating the bottom surface 110 of the housing 100 along the edge of the light emitting module 200, and the lower vent slots 130 mutually communicate with the second heat sinking path H2.

The housing 100 may further include a cover 500 that is connected to an upper edge of the side wall 120 and has communication holes 501 at the central portion thereof.

The cover 500 mutually communicates with the first and second heat sinking paths H1 and H2 and has the communication holes 501 at the central portion thereof. A plurality of upper vent slots 510 penetrating the circumferences of a plurality of concentric circles formed along the direction in which the cover 500 is formed.

To be specific, the communication holes 501 are connected to the communication spaces 101 through the first heat sink path H1, and the second heat sinking path H2 is connected through the outermost upper vent slot 510.

Referring to FIG. 3, the lower vent slots 130 mutually communicate through the upper vent slots 510. This can be understood more clearly with the detailed description of the heat sink unit 300, which will be described later.

As illustrated in FIGS. 1 and 4, the optical semiconductor lighting apparatus according to the embodiment of the present invention may further include a core fixing portion 400 that is disposed at the inner central portion of the bottom surface 110 of the housing 100 to fix an inner end portion of the heat sink unit 300.

In addition, although not specifically illustrated, a ventilation fan may be further mounted in the communication space 101 to forcibly convect heat generated from the light emitting module 200 and discharge the heat to the outside of the housing 100, thereby obtaining a rapid heat dissipation effect.

Meanwhile, as described above, the light emitting module 300 is mounted on the bottom surface 110 of the housing 100 so as to obtain excellent heat dissipation performance. The light emitting module 300 includes a plurality of unit heat sink elements 301 (see FIGS. 5 and 6) each including a pair of heat sink sheets 320 that are perpendicular to the bottom surface 110 of the housing 100 and face each other.

The outer end portion of the heat sink unit 300 communicates with the second heat sinking path H2 formed from the outer side of the bottom surface 110 of the housing 100.

More specifically, the heat sink unit 300 is disposed radially at the inner side of the bottom surface 110 of the housing 100, and includes a plurality of bottom sheets 310 contacting a side opposite to a side where the semiconductor optical device 201 is disposed, that is, the inner side of the bottom surface 110 of the housing 100.

The heat sink unit 300 includes heat sink sheets 320 that extend along both edges of the bottom sheet 310 and face each other.

Therefore, the first heat sinking path H1 is formed radially between the adjacent heat sink sheets 320. The second heat sinking path H2 is formed as follows.

That is, the second heat sinking path H2 is formed perpendicular to the first heat sinking path H1 vertically from the lower vent slots 130 in correspondence to the plurality of lower vent slots 130 penetrating the inner edge of the bottom surface 110 of the housing 100.

The outer end portion of the bottom sheet 310 is cut and removed, and a cut-out portion 315 is formed between the bottom sheet 310 and the heat sink sheet 320. Therefore, the cut-out portion 315 communicates with the lower vent slot 130. The second heat sinking path H2 may be formed through the upper vent slot 510 of the cover 500.

In this case, the heat sink unit 300 may include an extension sheet 311 extending from the inner end portion of the bottom sheet 310 toward the inner central portion of the bottom surface 110 of the housing 100, and a fixing sheet 312 extending along both edges of the extension sheet 311 and facing the extension sheet 311.

The extension sheet 311 provides a space for forming the fixing sheet 312. The fixing sheet 312 serves as a reinforcement structure for distributing and supporting a fixing/supporting force generated by the core fixing portion 400 fixing the upper edge of the fixing sheet 312.

As illustrated and described above, the core fixing portion 400 is disposed at the inner central portion of the bottom surface 110 of the housing 100.

Therefore, the communication space 101 is formed in the upper space of the core fixing portion 400, that is, the space between the plurality of bottom sheets 310 and the inner end portion of the heat sink sheet 320 from the inner central portion of the bottom surface 110 of the housing 100, and the communication space 101 mutually communicates with the first heat sinking path H1.

In addition, as illustrated in FIG. 5, the housing 100 may further include a plurality of fixing protrusions 160 protruding from the inner side of the bottom surface 110 and disposed along both edges of the bottom sheet 310, so as to provide a space for mounting the bottom sheet 310 constituting the unit heat sink element 301 and tightly fix and support the lower side of the heat sink sheet 320.

Furthermore, as illustrated in FIG. 6, the bottom sheet 310 is formed in a tapered shape, such that the bottom sheet 310 is gradually widened toward the inner edge of the bottom surface 110, so as to effectively discharge heat from the central portion of the bottom surface 110 to the outside of the housing 100.

Therefore, in the heat sink unit 300, the bottom sheet 310 and the heat sink sheet 320 constituting the unit heat sink element 301 are formed to have a U-shaped cross-section as a whole, and the bottom sheet 310 is disposed to contact the inner side of the bottom surface 110 of the housing 100. As a result, compared with the conventional heat sink fin structure, the heat transfer area is increased to further improve the heat dissipation effect.

In the conventional lighting apparatus, since the heat sink is manufactured by die casting, the volume and size thereof are increased. However, according to the embodiment of the present invention, the total weight of the product can be reduced by radially arranging the unit heat sink elements 301 including the bottom sheet 310 and the heat sink sheet 320 formed in a thin plate type.

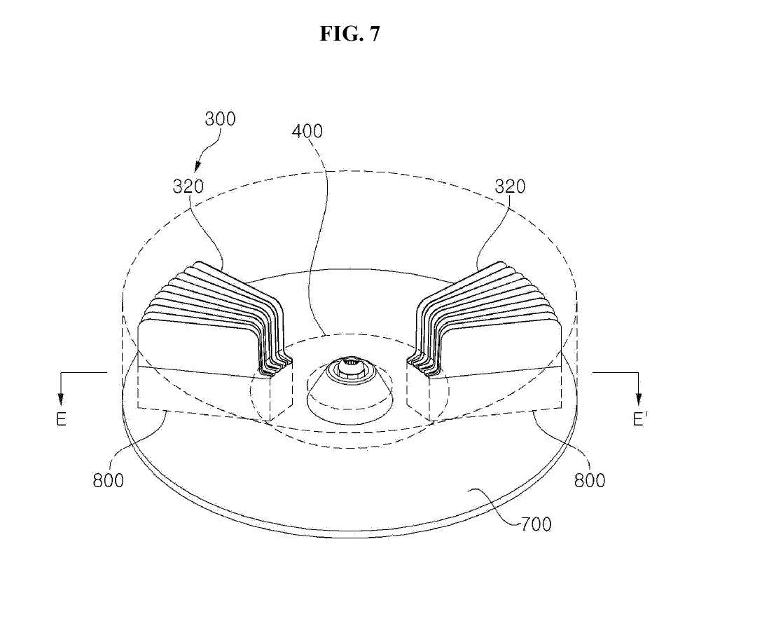

Meanwhile, as illustrated in FIGS. 7 to 19, the structures of a light engine concept can also be applied to the present invention.

In FIGS. 7 to 10, the same reference numerals as used in FIGS. 1 to 6 are assigned to members having the same structures and functions as those of FIGS. 1 to 6.

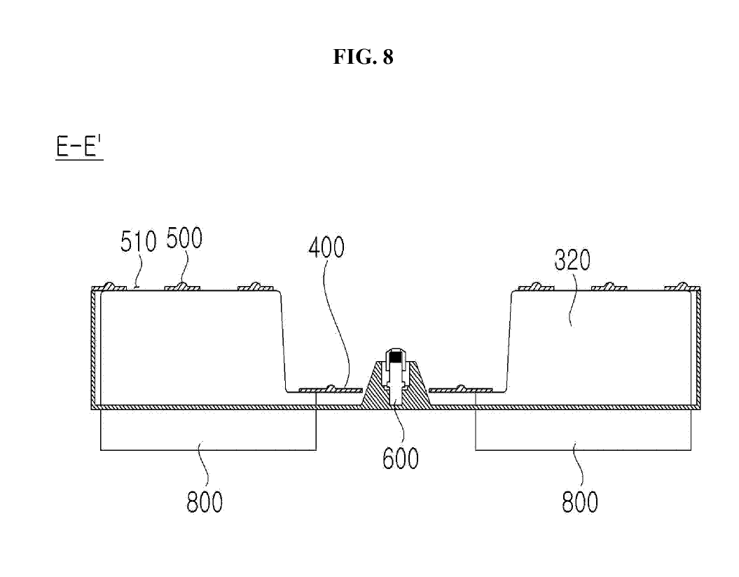

FIG. 7 is a perspective view illustrating an overall configuration of an optical semiconductor lighting apparatus according to an embodiment of the present invention. FIG. 8 is a cross-sectional view taken along line E-E′.

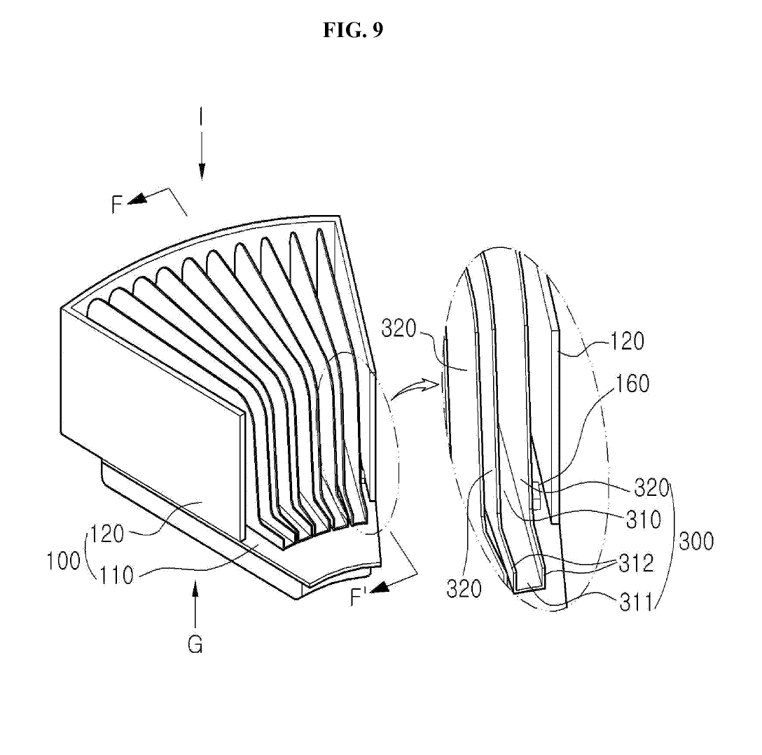

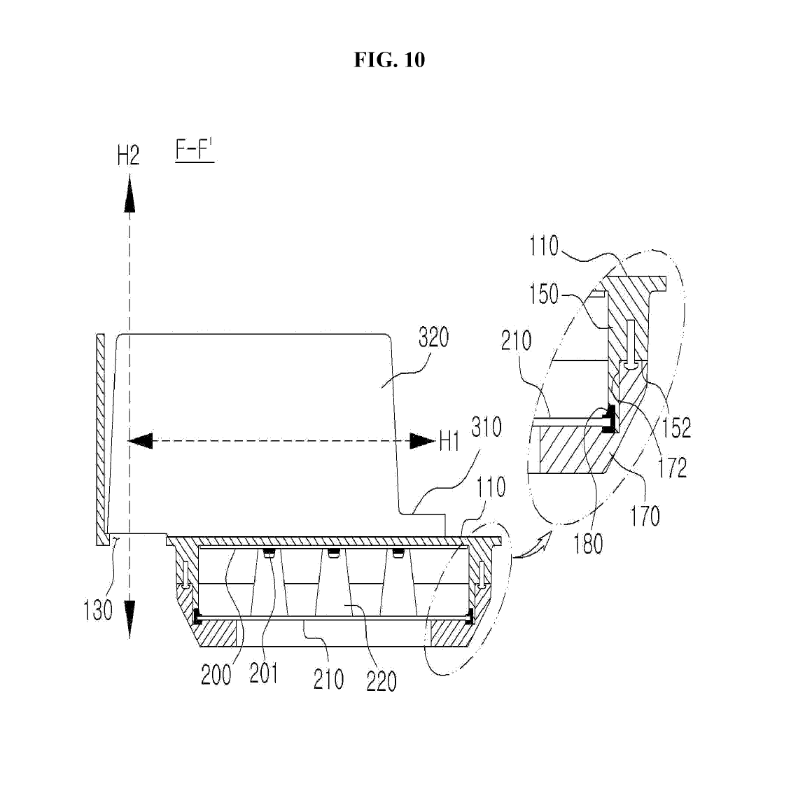

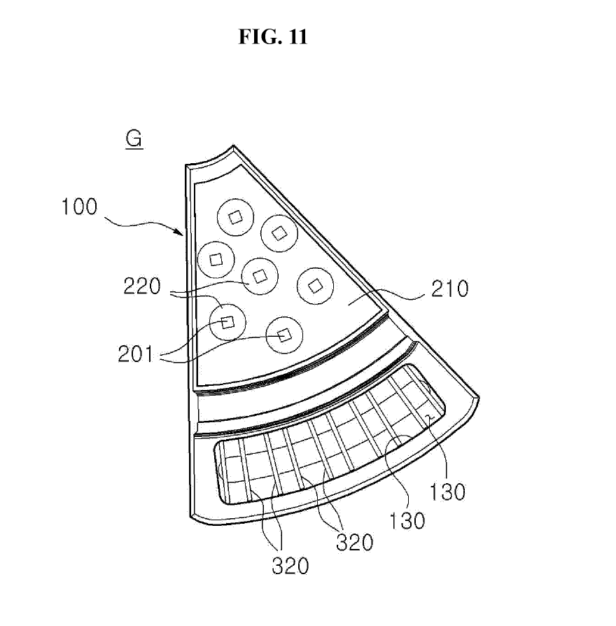

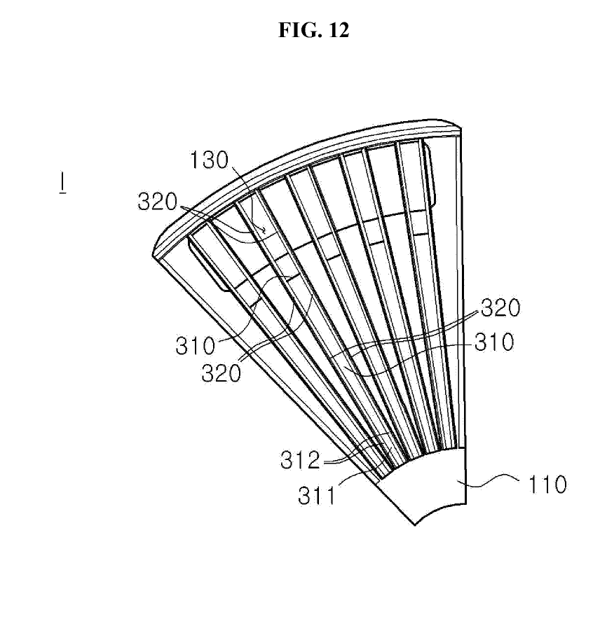

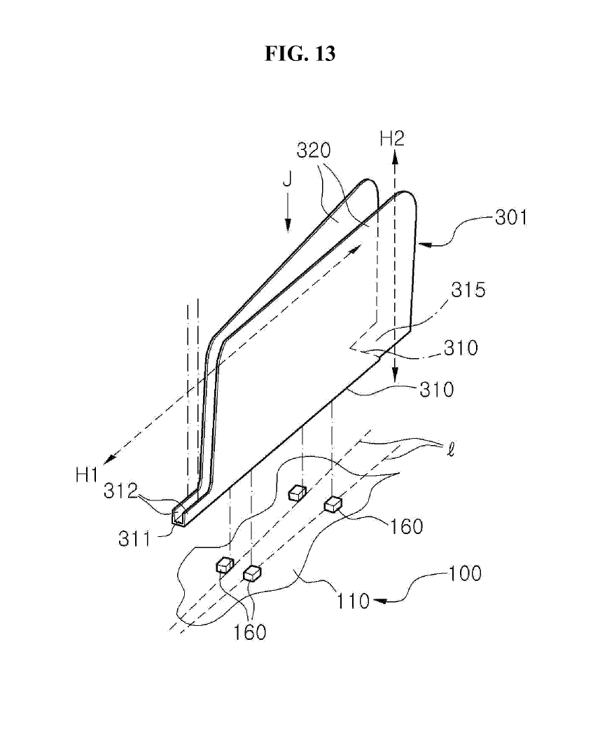

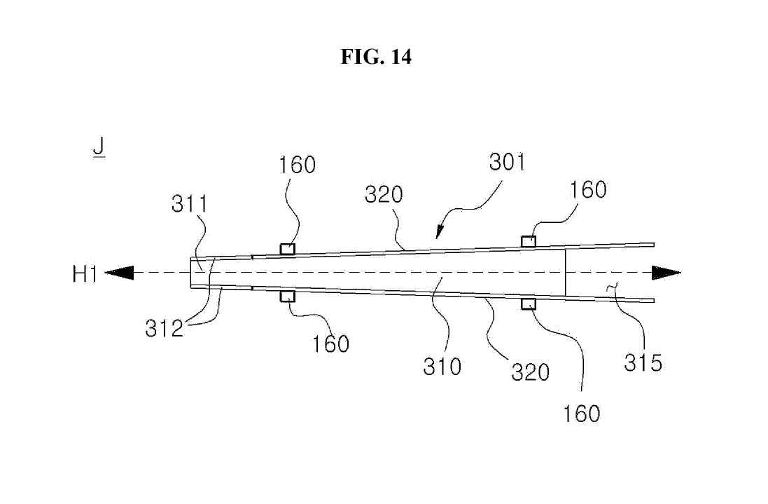

FIG. 9 is a perspective view illustrating an overall configuration of an optical semiconductor lighting apparatus according to another embodiment of the present invention. FIG. 10 is a cross-sectional view taken along line F-F′ of FIG. 9. FIG. 11 is a partial conceptual diagram viewed from a viewpoint G of FIG. 9. FIG. 12 is a partial conceptual diagram viewed from a viewpoint I of FIG. 9. FIGS. 13 to 14 are diagrams illustrating an overall configuration of a unit heat sink element constituting a heat sink unit that is an essential part of the optical semiconductor lighting apparatus according to another embodiment of the present invention.

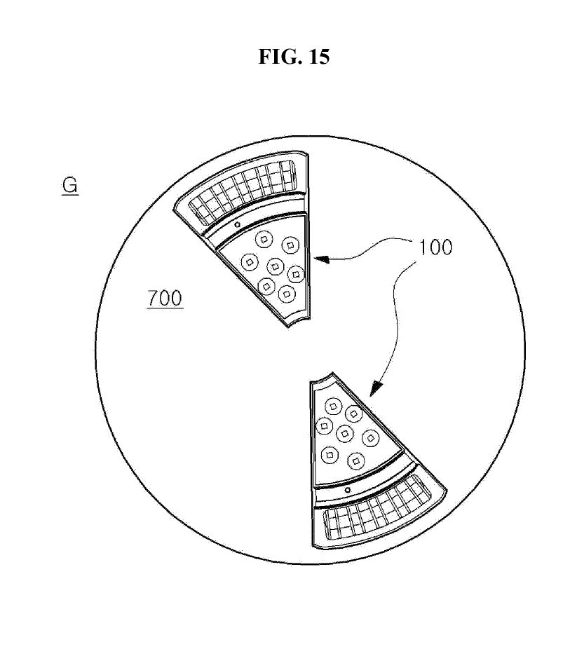

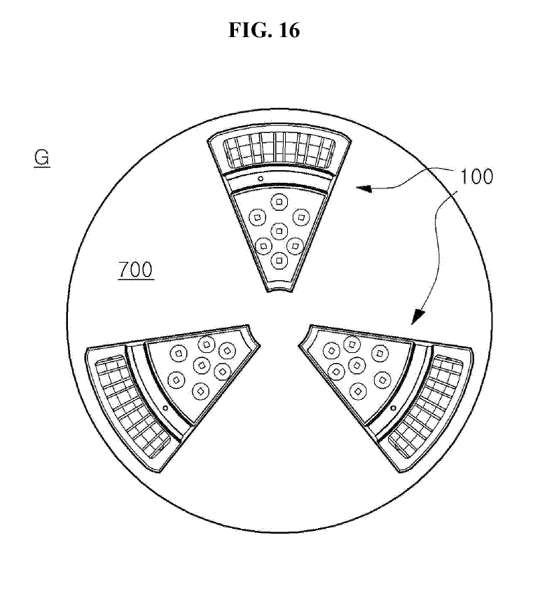

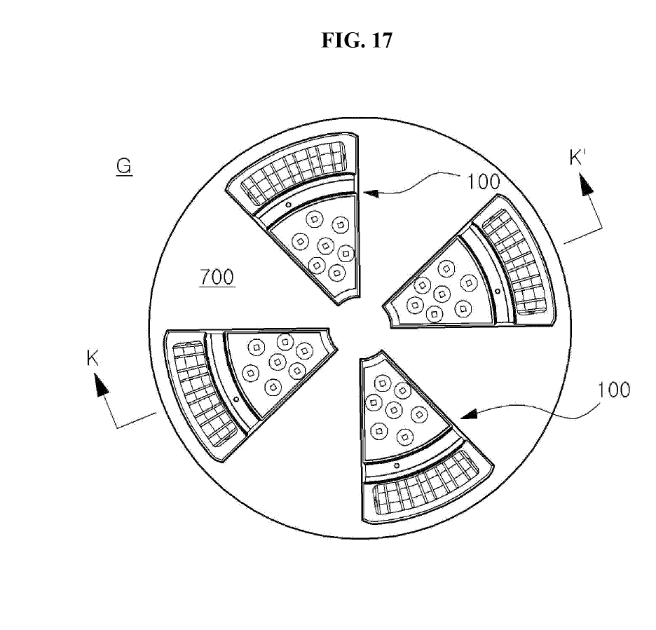

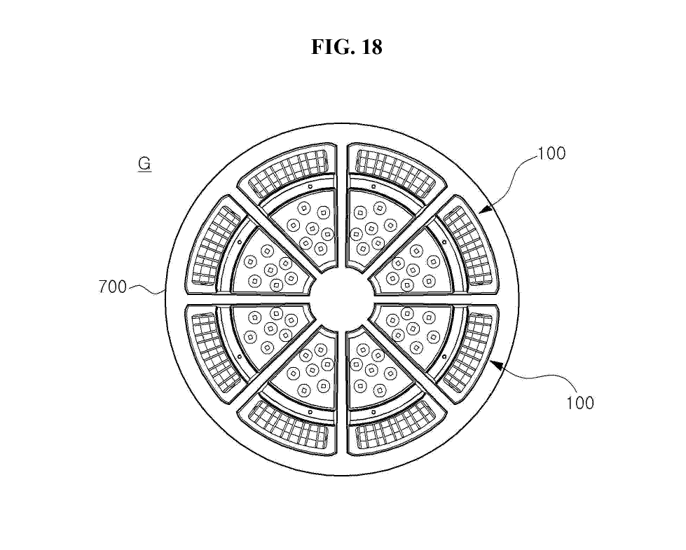

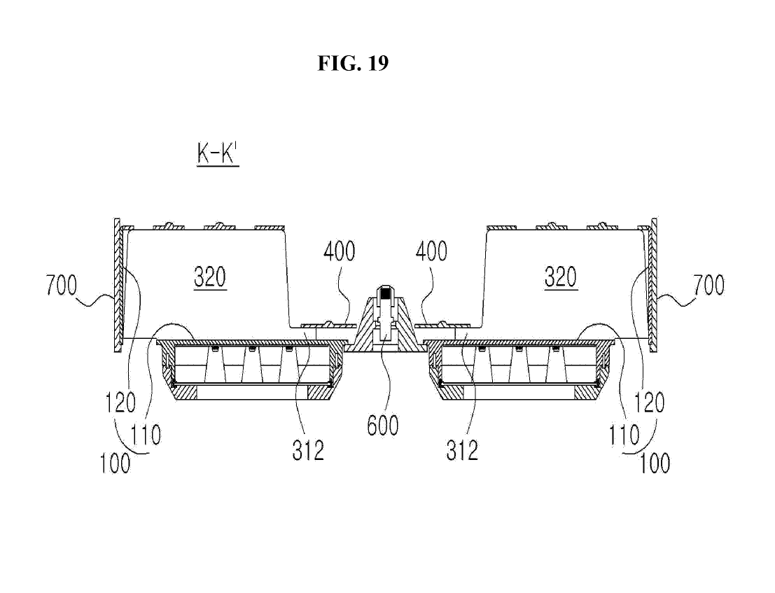

FIGS. 15 to 18 are conceptual diagrams illustrating actual application examples of optical semiconductor lighting apparatuses according to various embodiments of the present invention. FIG. 19 is a cross-sectional view taken along line K-K′ of FIG. 17.

In FIG. 8, reference numeral 600 denotes a waterproof connector.

In FIG. 9, the other side of the bottom surface 110 of the housing 100 refers to a side that gradually widens compared with one side thereof. One side of the bottom surface 110 of the housing 100 refers to a right lower end, and the other side thereof refers to a left upper end.

In FIG. 10, one side of the bottom surface 110 of the housing 100 refers to a right side, and the other side thereof refers to a left side.

In FIG. 11, one side of the bottom surface 110 of the housing 100 refers to a left upper side, and the other side thereof refers to a right lower side.

In FIG. 12, one side of the bottom surface 110 of the housing 100 refers to a right lower side, and the other side thereof refers to a left upper side.

In FIG. 13, one side of the bottom surface 110 of the housing 100 refers to a left lower side, and the other side thereof refers to a right upper side.

In FIG. 14, one side of the bottom surface 110 of the housing 100 refers to a left side, and the other side thereof refers to a right side.

In FIG. 19, reference numeral 600 denotes a waterproof connector. In FIGS. 7, 8, 9, 10 and 19, the outer side of the bottom surface 110 refers to a side facing a lower side of the drawing from the bottom surface 110, and the inner side of the bottom surface 110 refers to a side facing an upper side of the drawing from the bottom surface 110. The outer side and the inner side of the bottom surface 110 are equally applied throughout the drawings.

As illustrated, an engine body 800 is connected to an outer side of a bottom surface of the base casing 700, and a heat sink unit 300 is connected to an inner side of the bottom surface of the base casing 700.

The base casing 700 is a cylindrical member to provide a space for accommodating the heat sink unit 300, which will be described later, and also provide an area for mounting the engine body 800, which will be described later.

The engine body 800 is connected to the outer side of the bottom surface of the base casing 700 and is formed to have a top surface gradually widened from one side to the other side.

Although not specifically illustrated, it should be understood that the engine body 800 refers to a structure that includes a light emitting module (not illustrated) with semiconductor optical devices, and an optical member corresponding to the light emitting module. The engine body 800 is a structural concept extended up to a combination of a light emitting module and a power unit electrically connected thereto, which is defined in “Zhaga Consortium”, the consortium for standardization of LED light engines.

The heat sink unit 300 includes a plurality of unit heat sink elements 301 (see FIGS. 13 and 14) each including a pair of heat sink sheets 320 disposed at the inner side of the bottom surface of the base casing 700 in a fan shape and facing each other.

In this case, the number of the unit heat sink elements 301 may be appropriately increased or decreased according to the size of the housing 800, which is mounted on the outer side of the bottom surface of the base casing 700, or the light output amount of the light emitting module, which is mounted inside the engine body 800.

The heat sink unit 300 includes a bottom sheet 310 (see FIG. 9) contacting the base casing 700 so as to secure a sufficient heat transfer area, and a heat sink sheet 320 extends from both edges of the bottom sheet 310.

In addition, a plurality of engine bodies 800 are disposed radially from the central portion of the outer side of the bottom surface of the base casing 700. More specifically, in order to obtain excellent heat dissipation performance, the heat sink unit 300 may be disposed corresponding to a position where the engine body 800 is connected.

It is apparent that the following various embodiments as well as the above-described embodiment can also be applied to the present invention.

As described above, the base casing 700 provides a mounting space and area for the engine body 800 and the heat sink unit 300. As illustrated in FIG. 8, the base casing further includes a ring-shaped core fixing portion 400 for fixing the inner edges of the unit heat sink elements 301 at an upper side.

In addition, in order to protect the heat sink unit 300 and the components mounted inside the base casing 700 from external physical and/or chemical impacts, the base casing 700 may further include a ring-shaped cover 500 which is disposed at the upper side of the unit heat sink elements 301 and fixed to the edge of the base casing 700. Also, a plurality of upper vent slots 510 penetrate the cover 500.

In addition, the cover 500 is disposed at an upper side of the heat sink sheet 320 and connected to an upper edge of the base casing 700, such that heat generated from the light emitting module 200 is effectively discharged while inducing natural convection through the space where the heat sink unit 300 is formed.

Therefore, it is possible to cope with various installation and construction environments widely and actively by appropriately increasing or decreasing the number of the engine bodies 800 and the number of the unit heat sink elements 301 constituting the heat sink unit 300, regardless of the arrangement area in the inner and outer sides of the bottom surface of the base casing 700.

Meanwhile, in addition to the above-described structure, various structures illustrated in FIGS. 9 to 19 can also be applied to the present invention.

First, the heat sink unit 300 is included in the housing 100 where the light emitting module 200 is mounted.

The housing 100 forms the bottom surface 110 that is gradually widened from one side to the other side. To be specific, the housing 100 is formed in a fan shape to provide the space and area for mounting the light emitting module 200, the optical member, and the heat sink unit 300, which will be described later.

The light emitting module 200 includes at least one or more semiconductor optical devices 201 and is disposed at the outer side of the bottom surface 110 of the housing 100. The light emitting module 200 serves as a light source.

The optical member is connected to the outer side of the bottom surface 110 of the housing 100 and faces the light emitting module 2000. The optical member can adjust the light distribution area of light irradiated from the light emitting module 200.

In order to discharge generate from the light emitting module 200 to the outside of the housing 100, the heat sink unit 300 includes the plurality of unit heat sink elements 301 each including a pair of heat sink sheets 320 that are radially disposed in a fan shape at the inner side of the bottom surface 110 of the housing 100 and face each other.

Therefore, due to the structural characteristics of the bottom surface 110 of the housing 100, the above-described structure and the optical semiconductor lighting apparatus according to the embodiment of the present invention can adjust the light output amount by mounting a plurality of base casings 700 (see FIGS. 15 to 19), which will be described later.

As described above, the housing 100 provides the space and area for mounting the respective components of the present invention. The housing 100 further includes a side wall 120 extending along both sides of the bottom surface 110 and the edge of the other side of the housing 100, and the heat sink unit 300 is accommodated in the inner space where the side wall 120 is formed.

As described above, the optical member faces the light emitting module 200, and includes an optical cover 210 made of a transparent or translucent material. The optical cover 210 faces the light emitting module 200 and projects light irradiated from the light emitting module 200.

The optical member includes a lens 220 provided at the optical cover 210. The lens 220 corresponds to the semiconductor optical devices 201, and reduces or expands the area and range on which light is irradiated from the respective semiconductor optical devices 201.

Meanwhile, as illustrated in FIG. 10, the housing 100 may further include a connection rib 150 and a frame rib 170 so as to mount the optical member.

The connection rib 150 protrudes along the edge of the outer side of the bottom surface 110, and the frame rib 170 is connected to the connection rib 150. The edge of the optical member is fixed between the connection rib 150 and the frame rib 170.

The housing 100 may further include a first protrusion 152, which is stepped along the edge of the outer side of the connection rib 150, and a second protrusion 172, which is stepped along the edge of the outer side of the frame rib 170 and corresponds to the first protrusion 152.

The first protrusion 152 and the second protrusion 172 are provided for securely and tightly connecting the connection rib 150 and the frame rib 170. The first protrusion 152 and the second protrusion 172 are provided for securely fixing the optical member, that is, the edge of the optical cover 210.

In this case, a sealing member 180 may be connected to the optical member, that is, the edge of the optical cover 210, so as to maintain waterproofing and airproofing.

In addition, the housing 100 may further include the cover 500 disposed at the upper side of the heat sink sheet 320 and connected to the upper edge of the housing 100, such that heat generated from the light emitting module 200 is effectively discharged while inducing natural convection through the space where the heat sink unit 300 is formed.

Furthermore, the cover 500 protects the heat sink unit 300 and the components mounted inside the base casing 700 from external physical and/or chemical impacts.

The cover 500 may further include at least one or more upper vent slots 510 penetrating along a direction from one side to the other side of the housing 100.

In this case, the housing 100 may further include at least one or more lower vent slots 130 (see FIGS. 10 to 12) penetrating the edge of the other side of the bottom surface 110 thereof.

Meanwhile, as described above, the heat sink unit 300 is provided to obtain heat dissipation performance. The heat sink unit 300 includes a bottom sheet 310 contacting the inner side of the bottom surface 110 of the housing 100 so as to form the heat sink sheets 320 constituting the unit heat sink element 301.

The heat sink sheets 320 extend from both edges of the bottom sheet 310.

In this case, in the space formed between the heat sink sheets 320, the first heat sinking path H1 (see FIGS. 10, 13, and 14) are formed in a fan shape from one side to the other side of the bottom surface 110 of the housing 100.

In addition, the second heat sinking path H2 (see FIGS. 10 and 13) is formed from the lower vent slot 130 to the upper vent slot 510 disposed at the outermost of the cover 500.

Therefore, as illustrated, natural convection is actively induced by forming a plurality of paths through which heat generated from the light emitting module 200 is discharged by the first and second heat sinking paths H1 and H2, thereby further increasing the heat dissipation efficiency.

In addition, the heat sink unit 300 may further include an extension sheet 311 and a fixing sheet 312, which can be used when the heat sink unit 300 is fixedly arranged at the base casing 700 to be described later.

That is, the extension sheet 311 extends from the inner end portion of the bottom sheet 310 toward one side of the bottom surface 110 of the housing 100, and the fixing sheet 312 extends along both edges of the extension sheet 311 and faces the extension sheet 311.

In this case, the fixing sheet 312 is connected to the heat sink sheet 320. In order for assembly, it is preferable that the height of the fixing sheet 312 protruding from the bottom surface 110 is lower than that of the heat sink sheet 320.

Due to the structural characteristic of the bottom sheet 310 disposed radially on the bottom surface 110, it is preferable that the bottom sheet 310 is formed in a tapered shape such that the bottom sheet 310 is gradually widened from one side to the other side of the bottom surface 110, so as to secure a sufficient contact area.

In addition, as illustrated in FIG. 13, the housing 100 may further include a plurality of fixing protrusions 160 protruding on the opposite side and disposed along both edges of the bottom sheet 310, so as to provide a mounting space of the bottom sheet 310 constituting the unit heat sink element 301 and tightly fixing and supporting the lower side of the heat sink sheet 320.

Therefore, in the heat sink unit 300, the bottom sheet 310 and the heat sink sheet 320 constituting the unit heat sink element 301 are formed to have a U-shaped cross-section as a whole, and the bottom sheet 310 is disposed to contact the inner side of the bottom surface 110 of the housing 100. As a result, compared with the conventional heat sink fin structure, the heat transfer area is increased to further improve the heat dissipation effect.

In the conventional lighting apparatus, since the heat sink is manufactured by die casting, the volume and size thereof are increased. However, according to the embodiment of the present invention, the total weight of the product can be reduced by radially arranging the unit heat sink elements 301 including the bottom sheet 310 and the heat sink sheet 320 formed in a thin plate form.

Meanwhile, as illustrated in FIGS. 15 to 19, the optical power can be adjusted by arranging a plurality of housings 100 as the concept of the light engine, and the weight of the product can be reduced by increasing the arrangement efficiency of the semiconductor optical devices 201 per unit area. Moreover, the housing 100 can be arranged in the base casing 700 so as to provide high power products.

The heat sink sheets 320 of the heat sink unit 300 disposed in the adjacent housings 100 are disposed radially with respect to the central portion of the base casing 700.

To be specific, as illustrated in FIGS. 15 to 18, the plurality of housings 100 may be arranged radially with respect to the central portion of the base casing 700.

In this case, the arrangement efficiency of the housings 100 per unit area can be maximized when the other sides of the housings 100 are arranged to face the outer side of the base casing 700.

Although it is illustrated in the drawings that the base casing 700 has the bottom surface with a circular disk shape to form a cylindrical shape, the present invention is not necessarily limited thereto. Various applications and design modifications can also be made. For example, the base casing 700 may have a polygonal pillar shape with a polygonal bottom surface.

In addition, as illustrated in FIG. 19, the base casing 700 may include a core fixing portion 400 for pressing and fixing the upper edge of the fixing sheet 312. By arranging the core fixing portion 400 at the central portion of the base casing 700, the tightly connected state of the respective housings 100 can be maintained.

Therefore, as illustrated in FIGS. 15 to 18, when the housings 100 are arranged radially with respect to the central portion of the base casing 700, the first heat sinking path H1 is also formed radially. Therefore, heat generated from the light emitting module 200 can be effectively discharged through natural convention, together with the second heat sinking path H2.

In addition, although not specifically illustrated, a ventilation fan may be further mounted on the base casing 700 to forcibly force heat generated from the light emitting module 200 by convection and discharge the heat to the outside of the housing 100, thereby achieving a rapid heat dissipation effect.

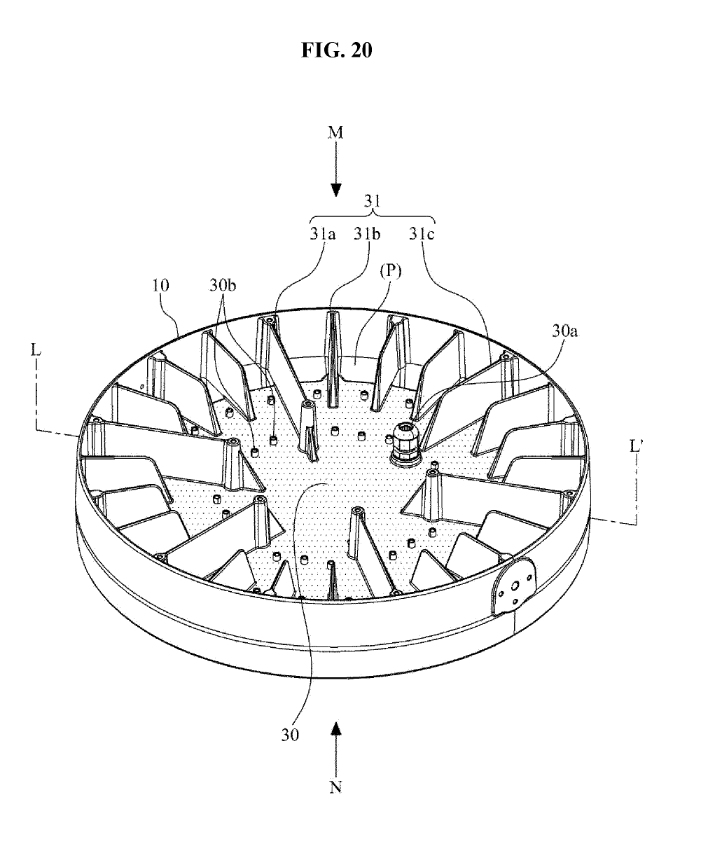

The optical semiconductor lighting apparatus according to another exemplary embodiment of the present invention will be described below in detail with reference to FIGS. 20 to 29.

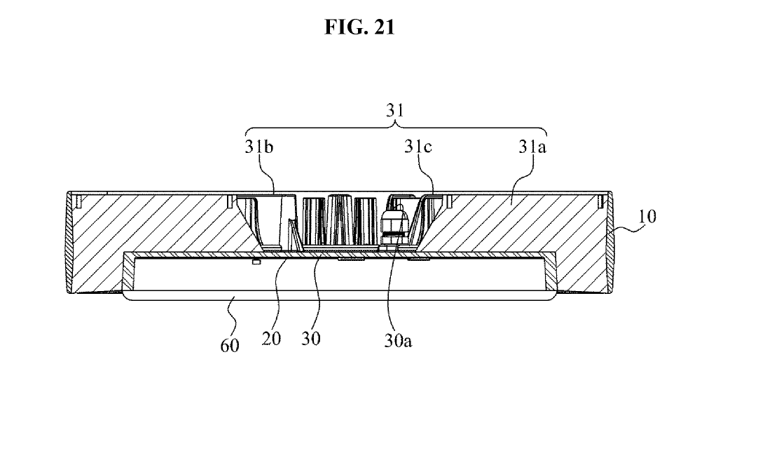

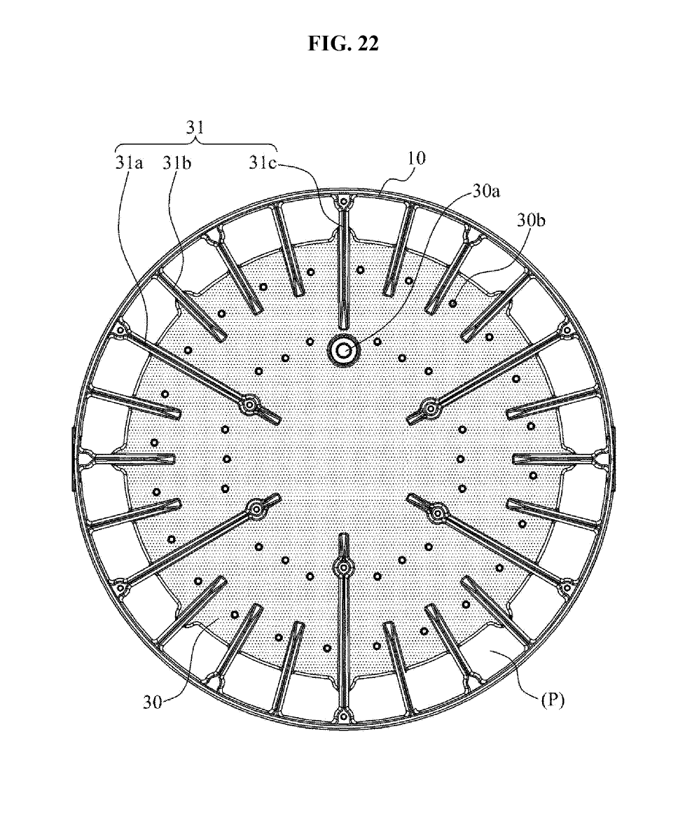

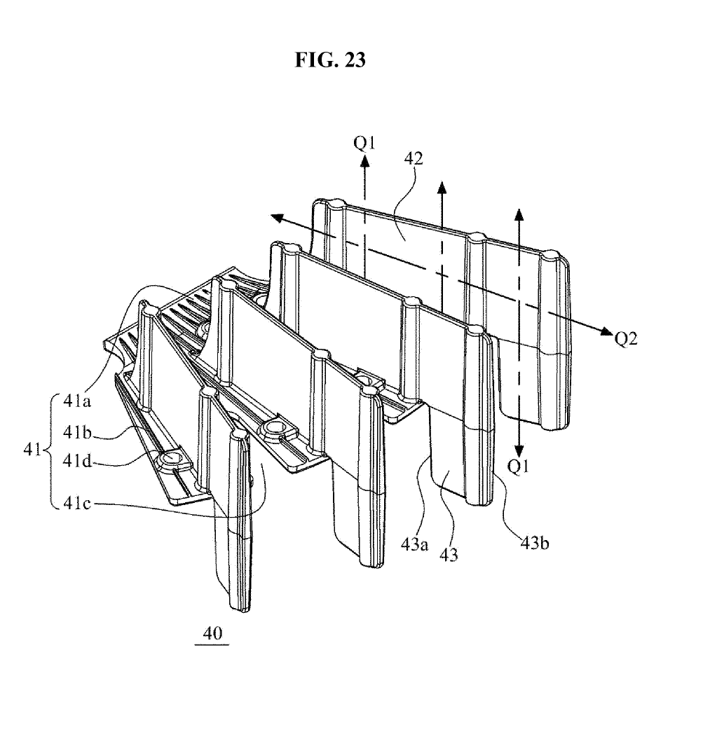

FIG. 20 is a perspective view of the optical semiconductor apparatus according to another embodiment of the present invention. FIG. 21 is a cross-sectional view taken along line L-L′ of FIG. 20. FIG. 22 is a conceptual diagram of the apparatus disclosed in FIG. 20 viewed from the viewpoint M of FIG. 20.

An upper surface of the apparatus disclosed in FIG. 20 can be recognized in FIG. 22 and the upper surface means a part of the apparatus viewed from the viewpoint M.

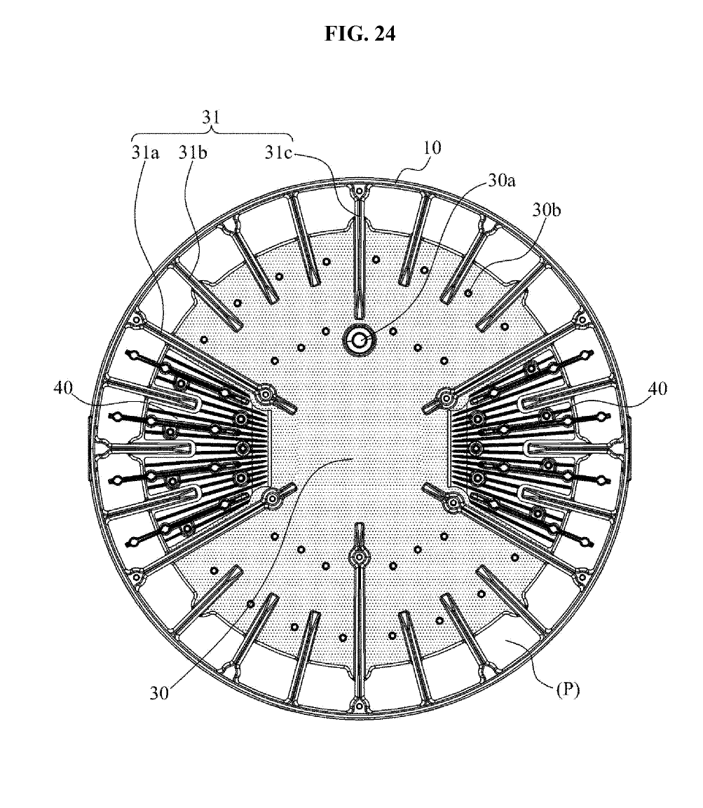

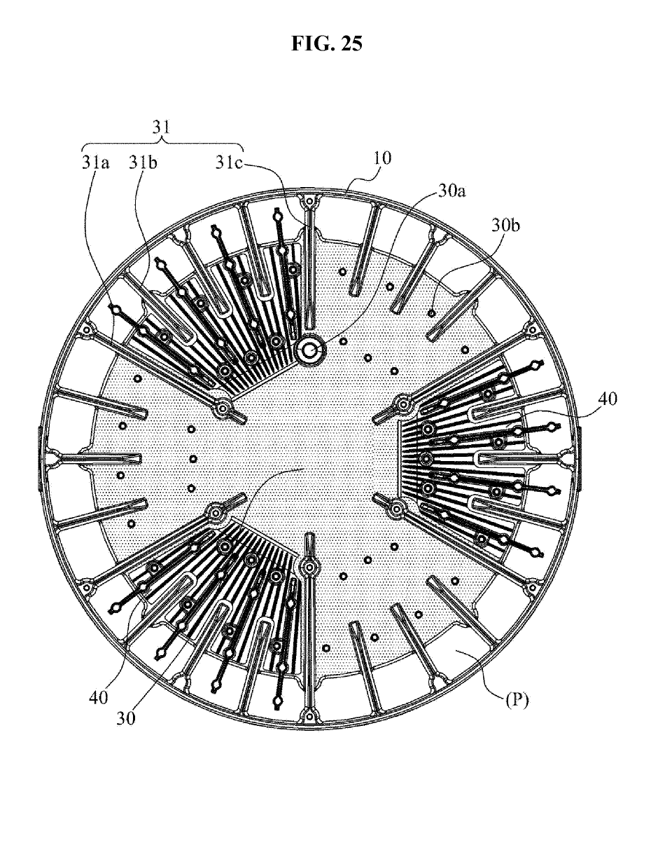

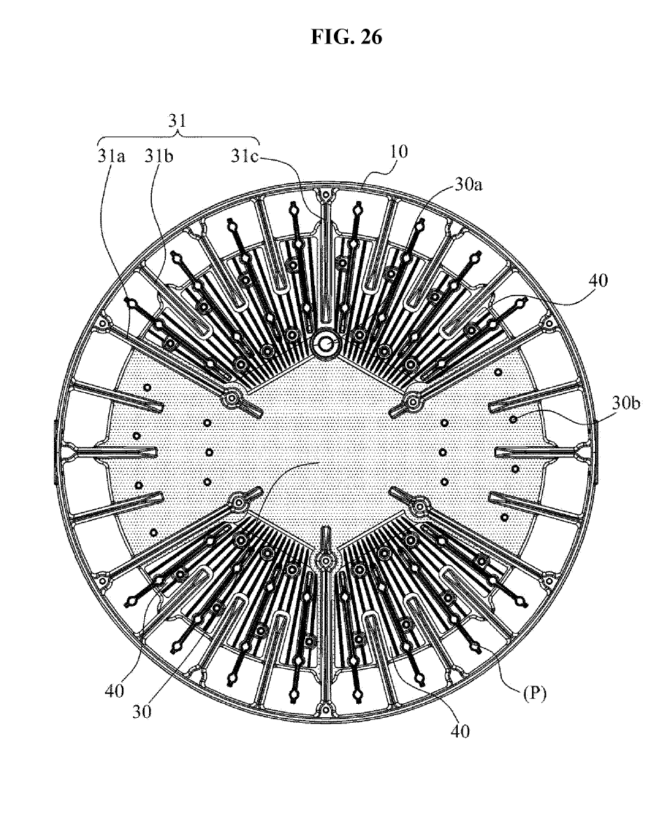

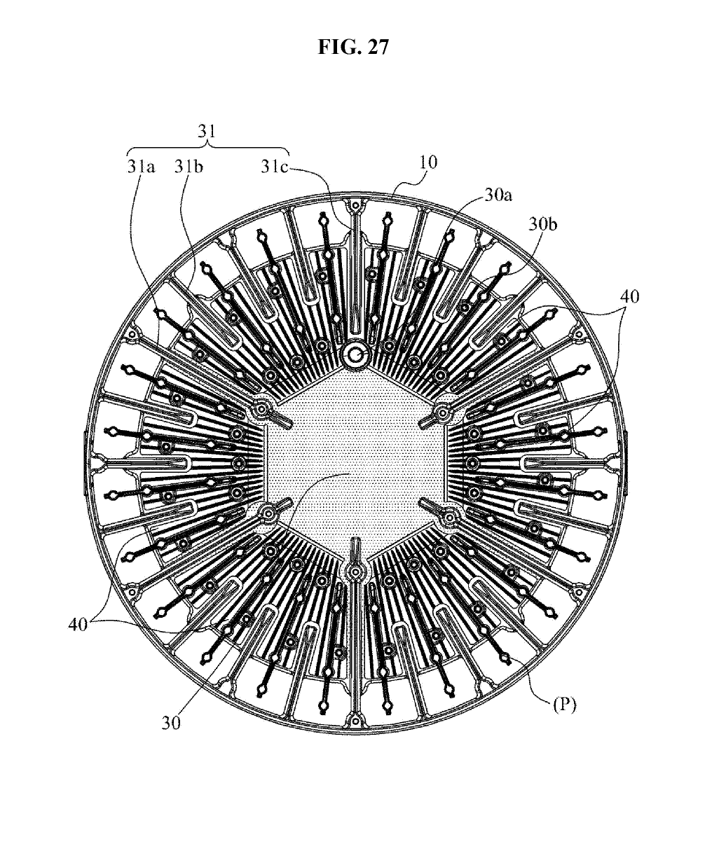

FIG. 23 is a perspective view illustrating an overall configuration of a first heat sink module that can be mounted on the apparatus disclosed in FIG. 20 to control heat radiation effectively, and the upper surface of the apparatus with the first heat sink modules mounted thereon can be recognized in FIGS. 24 to 27.

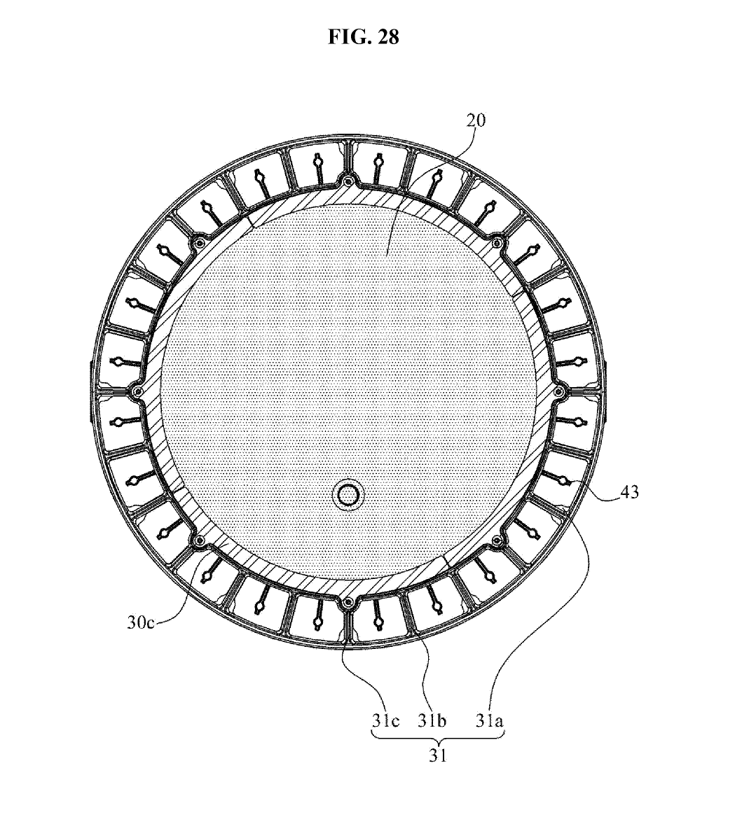

FIG. 28 is a conceptual diagram of the apparatus disclosed in FIG. 27 viewed from a viewpoint of N of FIG. 20.

A lower surface of the apparatus disclosed in FIG. 27 can be recognized in FIG. 28, and the lower surface means a part of the apparatus viewed from the viewpoint N of FIG. 20.

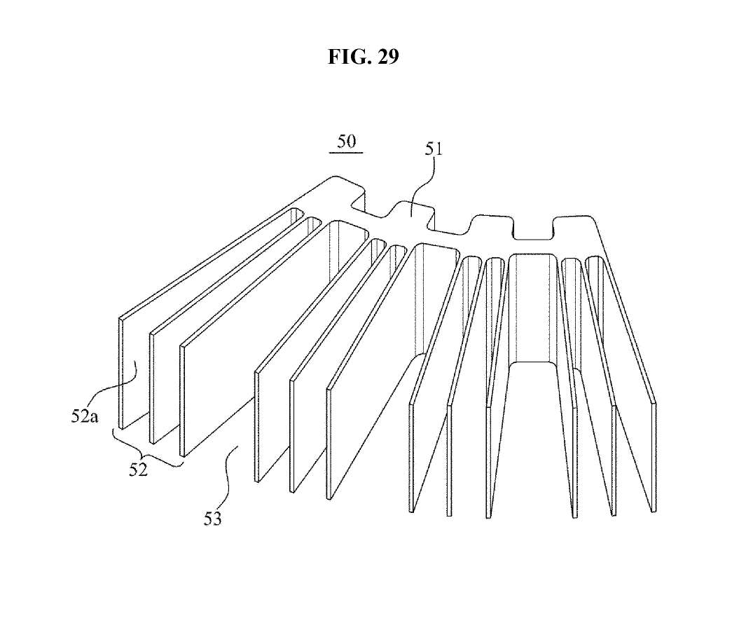

FIG. 29. is a perspective view illustrating an overall configuration of a second heat sink module that can be mounted on the apparatus disclosed in FIG. 20 to control heat radiation effectively.

The optical semiconductor lighting apparatus disclosed in FIGS. 20 to 22 according to another exemplary embodiment of the present invention includes side wall 10, a heat radiation plate 30, and heat radiation fins 31.

An LED lighting apparatus may weigh over 40 grams/Watt, so that an LED lighting apparatus with 300 W output may weigh over 12 kg. To set up that kind of a heavy apparatus, it is necessary to carry out reinforcement work on a basic supporting structure, such as a ceiling, and therefore, additional costs will be incurred as it is installed. The apparatus disclosed in FIGS. 20 to 22 has an effect of reducing the costs by weight reduction achieved by simplifying a basic structure.

Referring to FIG. 21, light emitting module 20 is disposed at the lower surface of the heat radiation plate 30. The light emitting module 20 has at least one semiconductor device and serves as a light source similar the module 200 disclosed in FIGS. 2 and 3 above.

The heat radiation plate 30 is an element which radiates heat generated from the light emitting module 20 disposed at the lower surface thereof.

The heat radiation plate 30 can be made of metallic materials having high heat conductivity. The conductivity is improved if the plate 30 becomes thinner and wider. Considering these, the plate 30 can be optimized depending on an amount of the heat generated from the module 20 and the installation condition of the light apparatus.

The upper surface of the plate 30 can be formed to have a circular shape, as shown in FIG. 22, but it is not so limited. Any appropriate shape can be selected from various shapes, such as a quadrangle, a polygon, etc., depending on the installation condition and to enhance the radiation effect maximally.

The upper surface of the plate 30 is shown in FIG. 22. The plate 30 has a regular height in a vertical direction similar to the optical semiconductor light apparatus disclosed in FIGS. 1 to 6.

The vertical direction means a straight direction from “the upper surface” to “the lower surface” or “the lower surface” to “the upper surface”, and this is identical to the direction designated as the second heat path H2 in FIG. 2.

The “regular height” means a distance in the vertical direction and the definition of “the regular height” is also applicable to the heat radiation fins 31 and the side wall 10, as described below.

The heat radiation plate 30 is exposed directly to the atmosphere so that it can radiate the heat transferred from the light emitting module 20 outside immediately.

Simultaneously, the plate 30 is also able to transfer the heat from the module 20 to the heat radiation fins 31 connected to it. As a result, the heat radiation plate 30 can carry out the heat radiation effectively.

Referring to FIG. 22, one side of each of the heat radiation fins 31 is connected to the center part of the heat radiation plate 30, and the other side each of the heat radiation fins 31 is connected to the side wall 10.

The “one side” of each of the fins 31 means a part of each of the fins 31 connected to the heat radiation plate 30, and “the other side” means another part of each of the fins 31 connected to the side wall 10.

It will be understood that “the center part” of the heat radiation plate 30 means a regular area of the upper surface of the plate 30 around the center point of the circular shape of the plate 30.

As described above, it is not necessarily limited to the circular form so that the center part can be an area around the center point of mass in any forms.

Referring to FIG. 22, a plurality of the fins 31 are formed radially having gaps along the edge of the plate 30. The gap between two fins adjacent to each other contributes to formation of a heat path P, as mentioned below.

The gap between two fins increases from the center part of the plate 30 to the side wall 10 if the fins 31 are radially disposed. The fins 31 also can be disposed having various gaps, and the designer will be able to select appropriate gaps depending on the air flow condition in the environment where the apparatus is installed.

Furthermore, the designer will be able to select appropriate number and length of the fins 31 considering heat radiation temperature, temperature of the environment, costs, etc.

The heat radiation fins 31 can be designed to include first heat radiation fins 31a, second heat radiation fins 31b, and third heat radiation fins 31c, which differ in length.

The different lengths of the fins 31 is beneficial in installing a heat sink module mountable additionally on the plate 30, or in deciding the position of a hole (30a, FIG. 22) for connecting power cable on the plate 30. Thus, it is possible to have various changes in the length of the fins 31 while designing the apparatus.

For example, the third heat radiation fins 31c in the middle length can be used depending on the position of the hole 30a for connecting power cable which is formed on the plate 30 (see FIG. 22).

Referring to FIG. 22, at least one of the second heat radiation fins 31b is disposed between two of the first heat radiation fins 31a, and one side of the fin 31b is connected to a part of the plate 30 separated away radially compared to one side of the fin 31a from the center point of the upper side of the plate 30, and the other side of the fin 31b is connected to the side wall 10 like the first heat radiation fins 31.

The shapes of the fins 31 can be formed to have various changes from one side to the other side depending on the height of the side wall 10 and the plate 30.

For example, if the height of the plate 30 is getting lower radially, the height of the fins 31 can be getting higher radially within the height of the side wall 10 (see FIG. 21).

A power supply or a cooling fan (not shown) can be disposed on the upper surface of the plate 30. In this case, a setting space for installing this equipment on the upper surface of the plate 30 can be secured by adjusting the number or the lengths of the fins 31 so that the height of the lighting apparatus can be reduced by installing that equipment in that space, and also a required space for setting up the lighting apparatus on a basic structure such as a ceiling can be minimized.

Referring to FIG. 22, the other sides of the fins 31 are connected to an inner surface of the side wall 10 having gaps along the inner surface in circumference direction.

The side wall 10 has a function of cooling the heat transferred from the plate 30 and the fins 31 by its surface contacting with the air, as well as a function of a housing, such as protecting and surrounding the apparatus.

The side wall 10 also can be made of metallic materials having a high conductivity, and the plate 30 and the fins 31 can be made of the same materials with the side wall 10 to secure the effect of heat transfer.

As disclosed in FIG. 20, the side wall 10 can be formed in a ring shape like a cylinder having the regular height. The shape of the side wall 10 is not so limited and the most appropriate form can be selected from various forms such as a quadrangle, a polygon, etc, depending on the installation condition and to enhance the functions, as described above.

The side wall 10 is formed to be extended in vertical direction so that its shape contributes to forming a heat path P, as described below. Furthermore, the inner and the outer surface of the side wall 10 are all exposed to the air flow so that the direct contact area to the air can be maximized and, therefore, help to enhance the effect of heat radiation.

Referring to FIG. 22, the heat path P is formed by the side wall 10 and the fins 31 having the gaps connected to the inner surface of the wall 10.

The inner surface of the wall 10 means a part which the other sides of the fins 31 are connected to, and the inner surface of the wall 10 means a surface of the wall 10 facing the center of the apparatus while the outer surface of the wall 10 means a surface of the wall 10 facing the outside of the apparatus.

Referring to FIG. 22, a plurality of the heat paths P are formed by the gaps of the fins 31, the inner surface of the wall 10 and the edge of the plate 30.

Referring to the optical semiconductor lighting apparatus according to another exemplary embodiment of the present invention disclosed in FIGS. 20 to 29, the apparatus is opened to the atmosphere when looking at the upper surface of the plate 30 so that the heat transferred can be radiated directly from the upper surface of the plate 30.

Meanwhile, the flow of air heated by the fins 31 and the plate 30 can be guided by the fins 31, and the air can be also guided by the heat path P in the vertical direction of the wall 10.

As a result, the heat generated from the module 20 can be effectively radiated. The number of the heat paths P can be selected by adjusting the number of the fins 31, and the number of the fins 31 can be decided by calculating the amount of the heat generated depending on the power output of the apparatus.

Referring to FIG. 23, the first heat sink module 40 mountable on the apparatus disclosed in FIG. 20 is disclosed. The first heat sink module 40 includes a bottom piece 41, a vertical piece 42, and an extended piece 43.

The lower surface of the bottom piece 41 is coupled to the upper surface of the plate 30 so that it can absorb the heat transferred from the plate 30 effectively by surface-to-surface contact.

The bottom piece 41 comprises a midmost part 41a disposed at the center part on the upper surface of the plate 30 and a plurality of branch parts 41b extended radially from the midmost part 41a, and a containing part 41c is formed between the two branch parts 41b.

The second fins 31b can be wedged in the containing part 41c to stably mount the module 40 on the upper surface of the plate 30 (see FIGS. 24 to 27).

By aligning holes 41d and 30b, the bottom piece 41 can be coupled to the plate 30 by screws (see FIGS. 24 to 27). However, other coupling methods may also be used. For example, a method such as a press-fitting can be used without using any additional elements.

In case of press fitted, a piece of module 40 can be wedged between two first heat radiation fins 31a, while the second heat radiation fins 31b stably mounts the module 40 on the plate 30 (see FIG. 24).

The vertical piece 42 can be formed parallel to the fins 31, and it is formed to the bottom piece 41 so that it can radiate the heat transferred from the bottom piece 41.

The vertical piece 42 can provide a heat path Q1 to make the heat transferred from the bottom piece 41 radiate upward directly, and a heat path Q2 guiding the heated air flow along the fins 31 from the one side to the other side of the fins 31. The shape of the path Q2 can be formed similarly to a fan-shaped from the center of the plate 30.

The extended piece 43 is extended downwardly from the end portion of the vertical piece 42 in the radial direction. The extended piece 43 includes an outer piece 43b close to the wall 10 and an inner piece 43a able to be in contact with the edge of the plate 30.

Consequently, the inner piece 43a can enhance the effect of the heat radiation since it can have the heat transferred from the vertical piece 42, and the heat radiation plate 30 directly, as well. Further, the air heated can be also guided by the extended piece 43 in the vertical direction of the wall 10. As a result, the heat generated from the module 20 can be effectively radiated. The designer will be able to select appropriate number of the vertical piece 42 and the extended piece 43 coupled to that by calculating the amount of the heat generated depending on the power output of the apparatus.

Referring to FIGS. 24 to 27, the optical semiconductor lighting apparatus includes the first heat sink modules 40 mounted thereon. As disclosed in those FIGS., the numbers of the module 40 can be decided considering the heat to be settled depending on the installation environment, the power output of the apparatus, etc.

As a result, the optimized number of the module 40 can be selected so that it is possible to prevent unnecessary cost of materials and proceed with installation for the apparatus effectively by weight lightening.

Referring to FIG. 28, the lower surface viewed from below is disclosed regarding the apparatus disclosed in FIG. 27

Referring to FIGS. 21 and 28, the light emitting module 20 is disposed on the lower surface of the plate 30, and the area of the module 20 can be smaller than that of the plate 30 so that the plate 30 can be formed to surround the edge of the module 20.

An optical member 60 can be disposed below the module 20 facing it and silicon molding or screw can be used for attaching the member to the lower surface of the outer part 30c of the heat radiation plate 30 (see FIG. 28). As described above regarding various embodiments of the present invention, the optical member can adjust the light distribution area of light radiated from the light emitting module 20.

As is disclosed in FIG. 28, the outer part 30c of the heat radiation plate 30 is connected to the side wall 10 through the fins 31 so that the heat from the module 20 is transferred effectively.

Further, if the extended piece 43 of the first heat sink module 40 is mounted on the plate 30, the effect of heat radiation will be enhanced because the inner piece 43a of the extended piece 43 is in contact with the plate 30, as described above.

Referring to FIG. 29, a second heat sink module is disclosed as another exemplary embodiment of the heat sink module.

The second heat sink module 50 comprises the center piece 51 coupled to the upper surface of the plate 30 by surface-to-surface contact, and at least one heat radiation pieces group 52 having a plurality of heat radiation pieces 52a extended radially from the center piece 51.

A plurality of the groups 52, like the branch parts 41b of the first heat sink module 40, are formed to be extended radially from the center piece 51, and a containing part 53 is formed between the two groups 52.

Likewise, the second fins 31b can be wedged in the containing part 53 to make the module 50 mounted on the upper surface of the plate 30 stably. The number of the heat radiation pieces 52a can be increased so that the contact area with the air can be increased sufficiently enough to enhance the effect of heat radiation, and the second heat sink module 50 can be made as one unit using a method such as die-casting so that the unit cost of production can decrease by the use of mass-production.

As described above, the basic technical spirit of the present invention is to provide an optical semiconductor lighting apparatus that can reduce the total weight of the product, can further improve the heat dissipation efficiency by inducing natural convection, is simple in the product assembly and installation and is easy in maintenance, and can provide products with high reliability by increasing the arrangement efficiency of semiconductor optical devices per unit area.

According to the present invention, the following effects can be obtained.

First, the heat sink unit is disposed radially in the housing where the light emitting module is mounted. The first heat sinking path is formed along the direction in which the heat sink is formed, and the second heat sinking path is formed in the vertical direction of the housing along the edge of the light emitting module. By actively inducing the natural convection through the first and second heat sinking paths, the heat dissipation efficiency can be significantly increased and the heat generation problem can be solved.

The heat sink sheets extend from both edges of the bottom sheet radially disposed in the housing including the semiconductor optical device, and have a U-shape facing each other. Therefore, the total weight of the product can be reduced, and the manufacturing cost of the product and the amount of raw materials used can be significantly reduced.

That is, by making the unit heat sink element in a sheet form, it is possible to solve the problem of the conventional heat sink manufactured by die casing that it is difficult to make the heat sink in the sheet form. Therefore, the weight of the product can be reduced, and the bottom sheet can solve the difficulty in securing the heat transferring area due to the line contact of the conventional sheet-type heat sink.

The unit heat sink element including the bottom sheet and the heat sink sheet is fit into the housing, and the cover where the upper vent slot is formed is connected to the housing. Since it is easy to assemble the product, failure sites can be checked immediately, and the maintenance and management are simple. Therefore, products with high reliability can be provided to consumers.

By providing the apparatus as the concept of the light engine including the engine body, the arrangement efficiency of the semiconductor optical devices per unit area can be increased, and products with high reliability can be provided.

That is, by arranging the engine bodies as the concept of the light engine radially in the base casing defining a separate accommodation space, high power lighting can be implemented. Furthermore, the output power can be appropriately varied according to the installation and construction environment.

While the embodiments of the present invention have been described with reference to the specific embodiments, it will be apparent to those skilled in the art that various changes and modifications may be made without departing from the spirit and scope of the invention as defined in the following claims.

What is claimed is:

1. An optical semiconductor lighting apparatus comprising:
a light emitting module comprising at least one semiconductor optical device;
a heat radiation plate having the light emitting module disposed at a lower surface thereof;
heat radiation fins formed radially with gaps, each of the radiation fins having one side thereof coupled to the heat radiation plate;
a side wall having the other side of each of the heat radiation fins with the gaps coupled to an inner surface thereof; and
heat paths formed by the gaps in the heat radiation fins, the inner surface of the side wall, and an edge of the heat radiation plate.

2. The optical semiconductor lighting apparatus of claim 1, wherein the side wall is formed as a ring shape having a regular height.

3. The optical semiconductor lighting apparatus of claim 1, wherein the heat radiation plate comprises an outer part connected to the side wall through the heat radiation fins and surrounding an edge of the light emitting module.

4. The optical semiconductor lighting apparatus of claim 1, wherein:
the heat radiation fins comprise first heat radiation fins each having one side thereof coupled to the center part of the heat radiation plate and the other side thereof coupled radially to the inner surface of the side wall; and
at least one second heat radiation fin disposed between two of the first heat radiation fins and has one side thereof coupled to a part of the heat radiation plate that is radially spaced from the center point of an upper surface of the heat radiation plate, and the other side thereof is coupled to the inner surface of the side wall.

5. The optical semiconductor lighting apparatus of claim 4, further comprising at least one first heat sink module, wherein:
the first heat sink module comprises a bottom piece coupled to the upper surface of the heat radiation plate;
a vertical piece extended upwardly from the bottom piece; and
a extended piece extended downwardly from the end portion of the vertical piece in a radial direction.

6. The optical semiconductor lighting apparatus of claim 5, wherein:
the first heat sink module is disposed between two of the first heat radiation fins;
the bottom piece has branch parts extended radially from a midmost part on the upper surface of the heat radiation plate;
a containing part is formed between two of the branch parts; and
one side of each of the second heat radiation fins is wedged in the containing part.

7. The optical semiconductor lighting apparatus of claim 4, further comprising at least one or more second heat sink modules,
wherein:
the second heat sink module comprises a center piece coupled to the upper surface of the heat radiation plate; and
a heat radiation pieces group comprising a plurality of heat radiation pieces extended radially from the center piece.

8. The optical semiconductor lighting apparatus of claim 7, wherein:
the second heat sink module is disposed between two of the first heat radiation fins;
a containing part is formed between two of the heat radiation pieces groups; and
one side of each of the second heat radiation fins is wedged in the containing part.
